(19) United States
(12) Patent Application Publication
(10) Pub. No.: US 2020/0122539 A1
(43) Pub. Date: Apr. 23, 2020

(54) SUSPENSION SYSTEM FOR A VEHICLE

(71) Applicant: Volvo Construction Equipment AB, Eskilstuna (SE)

(72) Inventor: Martin Gummesson, Tjureda (SE)

(21) Appl. No.: 16/627,843

(22) PCT Filed: Jul. 7, 2017
(86) PCT No.: PCT/EP2017/067106

§ 371 Date: Dec. 31, 2019

(51) Int. Cl. B60G 17/016; B60G 21/067; B60G 13/08; B60G 17/08

(52) U.S. Cl. CPC B60G 17/016; B60G 21/067; B60G 13/08; B60G 2300/02; B60G 2400/41; B60G 2400/204; B60G 2202/24; B60G 17/08

(57) ABSTRACT

A suspension system for a vehicle includes a first suspension arrangement including a first hydraulic cylinder; a second suspension arrangement including a second hydraulic cylinder; and a valve unit between the first and second hydraulic cylinders. The valve unit is controllable between a first state in which a piston side of the first hydraulic cylinder and a piston rod side of the second hydraulic cylinder are in fluid communication, and a piston rod side of the first hydraulic cylinder and a piston side of the second hydraulic cylinder are in fluid communication; and a second state in which the piston side of the first hydraulic cylinder and the piston side of the second hydraulic cylinder are in fluid communication, and the piston rod side of the first hydraulic cylinder and the piston rod side of the second hydraulic cylinder are in fluid communication.

### TECHNICAL FIELD

The present invention relates to a suspension system for a vehicle. The invention also relates to a corresponding method for selectively controlling a suspension system of a vehicle. The invention is applicable on vehicles, in particularly working machine, such as e.g. an articulated hauler. Although the invention will mainly be described in relation to an articulated hauler, it may also be applicable for other type of vehicles such as dump trucks, etc.

### BACKGROUND

In connection to working machine, in particularly working machines in the form of so-called articulated haulers, the comfort and driving performance are important design aspects to take into consideration. As the articulated haulers have a pivot connection between the front and rear portions allowing a mutual rotation around a longitudinal geometric axis of the vehicle, the articulated hauler is relatively “unstable” as the rear portion can rotate relative the front portion when e.g. driving at bulky terrain.

An articulated hauler is commonly provided with a boogie to level out ground imperfections. The boogie allows the chassis of the vehicle to be pushed in an upwards direction when, for example, one of the wheels is driven over a rock or the like. This is accomplished by using hydraulic cylinders in connection with each of the wheels and the boogie. When driving over the rock with the left side wheel, the left side piston of the left side hydraulic cylinder is pushed towards a piston side of the left side hydraulic cylinder. Hereby, hydraulic fluid is pushed from the piston side of the left side hydraulic cylinder to the piston side of the right side hydraulic cylinder, forcing the right side piston in a downwards movement relative the right side hydraulic cylinder.

However, operating the vehicle with the above described boogie will reduce the driving performance when operating the articulated hauler in a non-bulky terrain. There is a thus a desire to improve the driving performance in such situations. However, by improving driving performance, the boogie performance will be reduced. There is thus a desire to be able to provide sufficient driving performance while at the same time maintaining the boogie characteristics of the vehicle.

### SUMMARY

It is an object of the present invention to provide a suspension system which at least partially overcomes the above described deficiencies. This is achieved by a suspension system according to claim 1.

According to a first aspect of the present invention, there is provided a suspension system for a vehicle, the suspension system comprising a first suspension arrangement comprising a first hydraulic cylinder; a second suspension arrangement comprising a second hydraulic cylinder; and a valve unit arranged in fluid communication between the first and second hydraulic cylinders, wherein the valve unit being controllable between a first state in which a piston side of the first hydraulic cylinder and a piston rod side of the second hydraulic cylinder are arranged in fluid communication with each other, and a piston rod side of the first hydraulic cylinder and a piston side of the second hydraulic cylinder are arranged in fluid communication with each other; and a second state in which the piston side of the first hydraulic cylinder and the piston side of the second hydraulic cylinder are arranged in fluid communication with each other, and the piston rod side of the first hydraulic cylinder and the piston rod side of the second hydraulic cylinder are arranged in fluid communication with each other.

The wording “piston side” should be understood to mean the portion of the cylinder which will have a reduced volume when the piston is pushed into the cylinder. The wording “piston rod side” should thus be understood to mean the portion of the cylinder which will have a reduced volume when the piston is moved in the opposite direction, i.e. when the piston rod is moved out from the cylinder. Hence, the piston is movable within the cylinder between the piston side and the piston rod side.

The valve may be controlled between the first and second states manually or by means of a control unit receiving input signals relating to the operating state of the vehicle, as will be described further below.

Furthermore, the suspension system may be a wheel suspension system, as is described below. However, the suspension system may also be arranged in other configurations as well, such as e.g. a vehicle cabin suspension system, etc.

An advantage is that the suspension system can be controlled between a so-called “anti-roll bar mode” and a so-called “boogie mode”. In detail, when valve unit is arranged in the first state, hydraulic fluid is allowed to flow between the piston side of the first hydraulic cylinder and the piston rod side of the second hydraulic cylinder, and vice versa. Hereby, when, for example, a piston of the first hydraulic cylinder is moved in an upward direction, the fluid connection between the first and second cylinders is arranged such that the piston of the second cylinder will also be moved in the upward direction. The first mode will thus provide for an improved driving performance of the vehicle, i.e. the vehicle will be operated in a relatively stable manner, in the following also referred to as the “anti-roll bar mode”.

On the other hand, when the valve unit is arranged in the second state, hydraulic fluid is allowed to flow between the piston side of the first hydraulic cylinder and the piston side of the second hydraulic cylinder, as well as between the piston rod side of the first hydraulic cylinder and the piston rod side of the second hydraulic cylinder. Hereby, when, for example, the piston of the first cylinder is moved in the upward direction, the fluid connection between the first and second cylinders is arranged such that the piston of the second hydraulic cylinder will move in the opposite direction within the second hydraulic cylinder. Hereby, an improved comfort for the vehicle is provided, in particularly when operating the vehicle in rough terrain. The vehicle is thus operated in the so-called “boogie mode”.

Accordingly, the vehicle will be able to be operated in the “anti-roll bar mode” when it is desired to operate the vehicle in a relatively stable manner, and operated in the “boogie mode” when it is desired to operate the vehicle with high comfort.

According to an example embodiment, the suspension system may further comprise a control unit for controlling the valve unit to be operated between the first and second states.

The control unit may include a microprocessor, microcontroller, programmable digital signal processor or another programmable device. The control unit may also, or instead, include an application specific integrated circuit, a programmable gate array or programmable array logic, a programmable logic device, or a digital signal processor. Where the control unit includes a programmable device such as the microprocessor, microcontroller or programmable digital signal processor mentioned above, the processor may further include computer executable code that controls operation of the programmable device.

The control unit may, as will also be described further below, be receive various types of input signal for determining operation of the valve in the first or second states.

According to an example embodiment, the first hydraulic cylinder may comprise a first reciprocating piston and the second hydraulic cylinder comprises a second reciprocating piston, the control unit being configured to receive a signal indicative of a position of the first and the second piston within the respective first and second hydraulic cylinder; compare the position of the first piston and the position of the second piston with each other; control the valve unit to be switchable between the first and second states if the relative position between the first and second pistons is below a predetermined threshold limit.

Hereby, the first and second reciprocating pistons are arranged at substantially the same position within their respective hydraulic cylinders when changing between the first and second states, or vice versa. This is advantageous as the pistons will not be “locked” in a specific position before operating the suspension system in one of the first and second states. The predetermined threshold limit may thus preferably be as close to zero as possible, although normal tolerances should be acceptable.

The control unit may receive signals from one or more level sensors of the vehicle for determining the position of the pistons within their respective hydraulic cylinders. The level sensors may be arranged as linear sensors, either arranged externally or internally of the hydraulic cylinders. According to another example, the level sensors may be formed by angular sensor(s) connected to a portion of the vehicle chassis and arranged to detect the angular displacement relative a longitudinal geometric axis of the vehicle.

According to an example embodiment, the valve unit may be controllable between the first and second states based on at least one of a steering direction and a vehicle speed of the vehicle.

Hereby, it can be determined if the vehicle is in need of being operated in a relatively stable manner or if it should be operated with high comfort. If, for example, the vehicle speed is relatively high and/or the vehicle is turning, there may be a desire to operate the vehicle in a relatively stable manner. On the other hand, if the speed is relatively slow and/or the vehicle is exposed to small steering wheel movements, it may be assumed that the vehicle is operated in a terrain condition in need of increased comfort.

According to an example embodiment, the control unit may be further configured to receive a signal indicative of a steering direction for the vehicle; compare the steering direction with a predetermined threshold angle; if an angle of the steering direction exceeds the predetermined threshold angle: control the valve unit to be positioned in the first state; and if the angle of the steering direction is below the predetermined threshold angle: control the valve unit to be positioned in the second state.

Hereby, if the vehicle is driven at a curve or the like, i.e. the angle of the steering direction is relatively high, it may be desirable to operate the vehicle in the “anti-roll bar mode”, while if the steering angle is relatively low, it may be assumed that the vehicle is operated in a way requiring improved comfort. The steering direction may be determined based on a rotation of the steering wheel or based on an angular displacement of the pivot joint connecting the front portion and the rear portion of the vehicle to each other.

According to another example, the control unit may receive a signal from a camera of the like of the vehicle. Hereby, an upcoming obstacle may be identified whereby the control unit can control the valve unit to be positioned in the second state before arriving at the obstacle. Likewise, the camera may detect a curve ahead of the vehicle and arrange the valve unit to be positioned in the first state. The control unit may likewise, or in combination, receive a signal from a GPS or the like, or from road/drive data received from precious driving on the road ahead. Such road/drive data may be received from logged road data by the vehicle specific vehicle or received from logged road data from surrounding vehicles.

According to an example embodiment, the control unit may be further configured to receive a signal indicative of an inclination in the transversal direction of the vehicle; compare the inclination with a maximum allowable inclination; and if the inclination exceeds the maximum allowable inclination: inhibit the valve unit from being positioned in the second state.

Hereby, if the vehicle is standing/driving in a relatively steep slope with e.g. the vehicle left side facing down the slope and the vehicle right side facing up the slope, it may be important to operate the vehicle in a stable manner. An advantage is thus that the vehicle will be prevented from being operated in the “boogie mode” as this may cause one of the pistons to reach its bottom end position within its hydraulic cylinder, thus providing an uncomfortable driving experience to the driver. In an extreme worst case scenario, the vehicle may be caused to roll over.

According to an example embodiment, the valve unit may be further controllable to assume a third state in which the first and second hydraulic cylinders are disconnected from each other.

According to an example embodiment, the valve unit may be further controllable to assume a fourth state in which the piston side and the piston rod side of the first hydraulic cylinder are arranged in fluid communication with each other, and the piston side and the piston rod side of the second hydraulic cylinder are arranged in fluid communication with each other.

Hereby, the hydraulic cylinders will be operated independently from each other. Disconnecting the fluid connection between the first and second hydraulic cylinders is beneficial when driving the vehicle straight ahead on a non-bulky road surface.

According to an example embodiment, the first and second hydraulic cylinders may be arranged on opposite sides of the vehicle as seen in the longitudinal direction of the vehicle.

According to an example embodiment, the suspension system may be a wheel suspension system, wherein the first and second hydraulic cylinders are arranged to be connected to a respective wheel axle or to a respective side of a wheel axle of the vehicle.

According to a further example, if the valve unit is positioned in the second state and the trailer unit rotates relative the tractor unit, the control unit may control flow of hydraulic fluid between the cylinders to compensate and balance the working machine.

According to a second aspect, there is provided a method for selectively controlling a suspension system of a vehicle, the vehicle being operated in at least a first and a second operating mode, wherein the suspension system comprises a first suspension arrangement comprising a first hydraulic cylinder, and a second suspension arrangement comprising a second hydraulic cylinder, wherein the first and second hydraulic cylinders are fluidly connectable to each other, wherein the method comprises the steps of receiving a driving parameter for the vehicle; determining if the vehicle is operated in the first operating mode or the second operating mode based on the received driving parameter for the vehicle; if the vehicle is operated in the first operating mode: connecting a piston side of the first hydraulic cylinder and a piston rod side of the second hydraulic cylinder to each other; and connecting a piston rod side of the first hydraulic cylinder and a piston side of the second hydraulic cylinder to each other; if the vehicle is operated in the second operating mode: connecting the piston side of the first hydraulic cylinder and the piston side of the second hydraulic cylinder to each other; and connecting the piston rod side of the first hydraulic cylinder and the piston rod side of the second hydraulic cylinder to each other.

Effects and features of the second aspect are largely analogous to those described above in relation to the first aspect.

According to a third aspect, there is provided a computer program comprising program code means for performing the steps of the second aspect when the program is run on a computer.

According to a fourth aspect, there is provided a computer readable medium carrying a computer program comprising program means for performing the steps of the second aspect when the program means is run on a computer.

According to a fifth aspect, there is provided a vehicle comprising a suspension system according to any one of the embodiments described above in relation to the first aspect.

Effects and features of the third, fourth and fifth aspects are largely analogous to those described above in relation to the first aspect.

Further features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

The above, as well as additional objects, features and advantages of the present invention, will be better understood through the following illustrative and non-limiting detailed description of exemplary embodiments of the present invention, wherein:

FIG. 1 is a lateral side view illustrating an example embodiment of a vehicle in the form of an articulated hauler;

FIG. 2 is a schematic illustration of a suspension system according to an example embodiment; and

FIG. 3 is a flow chart of a method for controlling the suspension system according to an example embodiment.

### DETAILED DESCRIPTION OF EXAMPLE EMBODIMENTS OF THE INVENTION

The present invention will now be described more fully hereinafter with reference to the accompanying drawings, in which exemplary embodiments of the invention are shown. The invention may, however, be embodied in many different forms and should not be construed as limited to the embodiments set forth herein; rather, these embodiments are provided for thoroughness and completeness. Like reference character refer to like elements throughout the description.

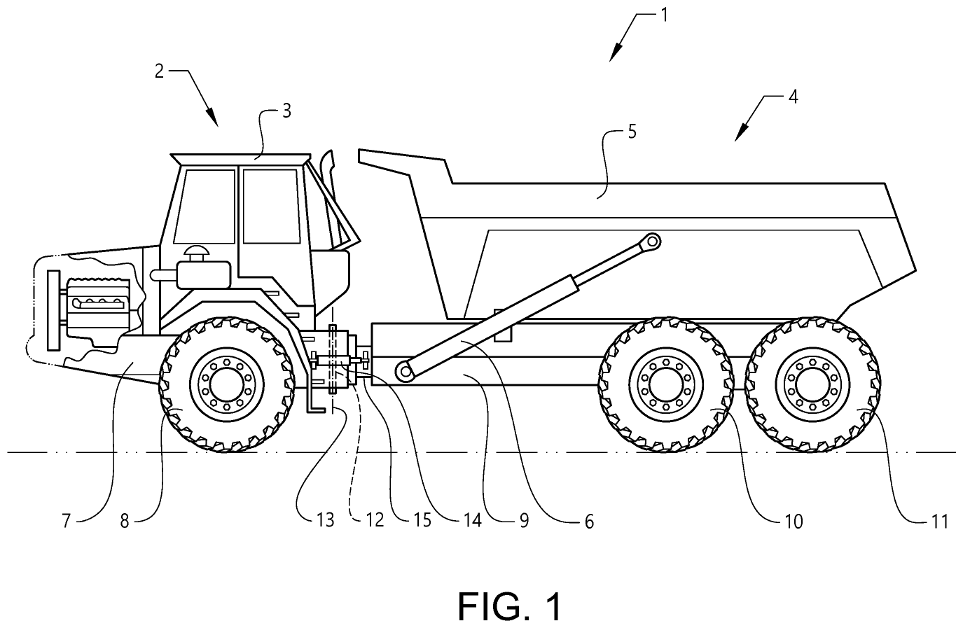

FIG. 1 is a side view of a working machine 1 in the form of an articulated hauler having a tractor unit 2 with a cab 3 for a driver and a trailer unit 4 with a platform having a dump body 5, here in the form of a container, arranged thereon, for receiving load. The dump body 5 is preferably pivotally connected to the rear section and tiltable by means of a pair of tilting cylinders 6, for example hydraulic cylinders. The tractor unit 2 has a frame 7 and a pair of wheels 8 suspended from the frame 7. The trailer unit 4 has a frame 9 and two pair of wheels 10, 11 suspended from the frame 9.

The working machine is frame-steered, i.e. there is a joint arrangement 12 connecting the tractor unit 2 and the trailer unit 4 of the working machine 1. The tractor unit 2 and the trailer unit 4 are pivotally connected to each other for pivoting around a substantially vertical pivot axis 13.

The working machine preferably comprises a hydraulic system having two hydraulic cylinders 14, steering cylinders, arranged on opposite sides of the working machine for turning the working machine by means of relative movement of the tractor unit 2 and the trailer unit 4. The hydraulic cylinders can, however, be replaced by any other linear actuator for steering the machine, such as an electromechanical linear actuator.

The working machine can further comprise a joint arrangement 15 connecting the tractor unit and the trailer unit of the working machine for allowing mutual rotation of the tractor unit and the trailer unit around a geometrical axis having a horizontal component in the longitudinal direction of the working machine.

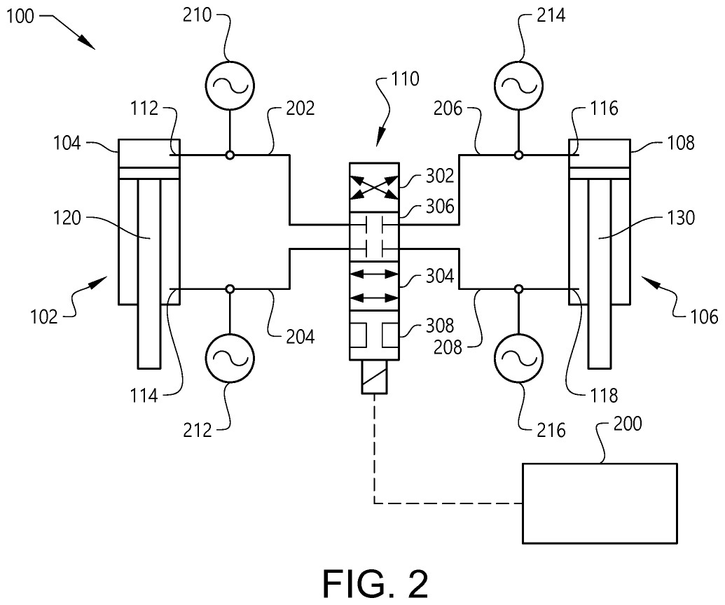

Furthermore, the working machine 1 comprises a suspension system (depicted in further detail in FIG. 2 and denoted as 100). The suspension system 100 is arranged to connect the wheels, in particular the pair of wheels 10, 11 on the trailer unit 4 to the frame 9 of the trailer unit 4.

Reference is therefore made to FIG. 2, which is a schematic illustration of a suspension system 100 according to an example embodiment. As described above, the suspension system 100 is preferably connected to the pair of wheels 10, 11 on the trailer unit 4. In particular, the suspension system 100 is connected to the pair of wheels 10, 11 on the left and right hand side of the vehicle 1.

As can be seen in FIG. 2, the suspension system 100 comprises a first suspension arrangement 102 and a second suspension arrangement 106. The first suspension arrangement 102 is preferably connected to the pair of wheels 10, 11 on the left hand side of the vehicle 1 and the second suspension arrangement 106 is connected to the pair of wheels 10, 11 on the right hand side of the vehicle 1. It should be noted that the first 102 and second 106 suspension arrangements may be connected to a single one of the wheels 10, 11 on the respective left and right hand side of the trailer unit 4. Alternatively, the first suspension arrangement 102 may also be connected to both of the wheels 10, 11 on the left hand side of the trailer unit 4, via a beam arrangement or the like (not shown).

As further depicted in FIG. 2, the first suspension arrangement 102 comprises a first hydraulic cylinder 104. The first hydraulic cylinder 104 comprises a first reciprocating piston 120 arranged within the first hydraulic cylinder 104. The first reciprocating piston 120 is arranged to reciprocate within the first hydraulic cylinder 104 between a piston side 112 and a piston rod side 114 of the first hydraulic cylinder 104. Furthermore, the first hydraulic cylinder 104 is connected, either directly or via another component, to the frame 9 of the trailer unit 4. The first reciprocating piston 120 on the other hand is connected, either directly or via another component, to the pair of wheels 10, 11 on the trailer unit 4. The first reciprocating piston 120 may be connected to the wheel axle (not shown) of one of the pair of wheels 10, 11 on the left hand side of the trailer unit 4. By means of the connection of the first hydraulic cylinder 104 and the first reciprocating piston 120, a suspension between the pair of wheels 10, 11 on the left hand side of the trailer unit 4 and the frame 9 of the trailer unit 4 is provided.

Moreover, the second suspension arrangement 106 comprises a second hydraulic cylinder 108. The second hydraulic cylinder 108 comprises a second reciprocating piston 130 arranged within the second hydraulic cylinder 108. The second reciprocating piston 130 is arranged to reciprocate within the second hydraulic cylinder 108 between a piston side 116 and a piston rod side 118 of the second hydraulic cylinder 108. Furthermore, the second hydraulic cylinder 108 is connected, either directly or via another component, to the frame 9 of the trailer unit 4. The second reciprocating piston 130 on the other hand is connected, either directly or via another component, to the pair of wheels 10, 11 on the trailer unit 4. The second reciprocating piston 130 may be connected to the wheel axle (not shown) of one of the pair of wheels 10, 11 on the right hand side of the trailer unit 4. By means of the connection of the second hydraulic cylinder 108 and the second reciprocating piston 130, a suspension between the pair of wheels 10, 11 on the right hand side of the trailer unit 4 and the frame 9 of the trailer unit 4 is provided.

Furthermore, the suspension system 100 comprises a valve unit 110. The valve unit 110 is arranged in fluid communication with the first 102 and second 106 suspension arrangements. In detail, the valve unit 110 is arranged in fluid communication with the piston side 112 of the first hydraulic cylinder 104 via a first piston side conduit 202, and in fluid communication with the piston rod side 114 of the first hydraulic cylinder 104 via a first piston rod side conduit 204. The valve unit 110 is arranged in fluid communication with the piston side 116 of the second hydraulic cylinder 108 via a second piston side conduit 206, and in fluid communication with the piston rod side 118 of the second hydraulic cylinder 108 via a second piston rod side conduit 208.

As further depicted in FIG. 2, the suspension system 100 further comprises a first hydraulic accumulator 210 arranged in fluid communication with the first piston side conduit 202, a second hydraulic accumulator 212 arranged in fluid communication with the first piston rod side conduit 204, a third hydraulic accumulator 214 arranged in fluid communication with the second piston side conduit 206, and a fourth hydraulic accumulator 216 arranged in fluid communication with the second piston rod side conduit 208. The accumulators 210, 212, 214, 216 are each arranged to receive hydraulic fluid as well as to supply hydraulic fluid to the respective portions of the first and second hydraulic cylinder. Hereby, hydraulic fluid can be relatively quickly supplied to the respective portions of the first and second hydraulic cylinder when desired.

As is also depicted in FIG. 2, the valve unit 110 is connected to a control unit 200 for operation thereof. The exemplified valve unit 110 in FIG. 2 is configured to be controllable between four different states. In particular, the valve unit 110 comprises a first position 302, a second position 304, a third position 306 and a fourth position 308. However, the valve unit 110 may be arranged to comprise only the first 302 and second 304 positions, or comprises the first 302, second 304 and one of the third 306 and fourth 308 positions. Other alternatives are also conceivable, such as a valve unit which is able to gradually switch between the different states. For example, the valve unit may be operated in the first position, i.e. 100% in the first state. The valve unit may thereafter be gradually switched towards the second state, such that the valve unit is assuming e.g. 80% of the first state and 20% of the second state. Hereby, 80% of the hydraulic fluid from the piston side 112 of the first hydraulic cylinder 104 is directed to the piston rod side 118 of the second hydraulic cylinder 106, while 20% of the hydraulic fluid from the piston side 112 of the first hydraulic cylinder 104 is directed to the piston side 116 of the second hydraulic cylinder 106. Such valve unit may be realized by placing the cross-coupling of the first position 302 and the parallel coupling of the second position 304 close to each other. Preferably, such valve unit may be realized by a rotatable valve unit where the cross-coupling and the parallel coupling are arranged above each other with the inlets and outlets towards the respective cylinders in close vicinity to each other, and the more the valve is rotated, the more flow area will be provided to the cross-coupling or to the parallel coupling. The valve unit may be kept in such intermediate position between the first and second position if this is desirable.

When the valve unit 110 is arranged in the first position 302, i.e. the valve unit 110 assumes a first state, hydraulic fluid is allowed to flow between the piston side 112 of the first hydraulic cylinder 104 and the piston rod side 118 of the second hydraulic cylinder 108, and vice versa, and hydraulic fluid is allowed to flow between the piston side 116 of the second hydraulic cylinder 108 and the piston rod side 114 of the first hydraulic cylinder 104, and vice versa. Hereby, when e.g. the piston 120 of the first hydraulic cylinder 104 is moved towards the piston side 112 of the first hydraulic cylinder 104, hydraulic fluid is forced from the piston side 112 of the first hydraulic cylinder 104 to the piston rod side 118 of the second hydraulic cylinder 108 via the first piston side conduit 202 and the second piston rod side conduit 208. When the valve unit 110 is arranged to assume the first state, the vehicle is operated in a relatively stable manner.

On the other hand, when the valve unit 110 is arranged in the second position 304, i.e. the valve unit 110 assumes a second state, hydraulic fluid is allowed to flow between the piston side 112 of the first hydraulic cylinder 104 and the piston side 116 of the second hydraulic cylinder 108, and vice versa, and hydraulic fluid is allowed to flow between the piston rod side 114 of the first hydraulic cylinder 104 and the piston rod side 118 of the second hydraulic cylinder 108, and vice versa. Hereby, when e.g. the piston 120 of the first hydraulic cylinder 104 is moved towards the piston side 112 of the first hydraulic cylinder 104, hydraulic fluid is forced from the piston side 112 of the first hydraulic cylinder 104 to the piston side 116 of the second hydraulic cylinder 108 via the first piston side conduit 202 and the second piston side conduit 206. When the valve unit 110 is arranged to assume the second state, the vehicle is operated in a relatively comfortable manner suitable when driving the vehicle in rough terrain, etc.

When positioning the valve unit 110 in the third position 306, i.e. the valve unit 110 assumes the third state, the first 104 and second 108 cylinders are disconnected from each other. In the third state, hydraulic fluid in the respective cylinder is prevented from flowing out from the respective piston sides 112, 116 or the respective piston rod sides 114, 118. When the valve unit 110 is arranged to assume the third state, flow is only allowed to be provided to/from the respective accumulators. A relatively stable, i.e. robust and rigid suspension is hereby provided which may be suitable when the working machine operates and is driven at a straight and flat surface.

Finally, when positioning the valve unit 110 in the fourth position 308, i.e. the valve unit 110 assumes the fourth state, the piston side 112 and the piston rod side 114 of the first hydraulic cylinder are arranged in fluid communication with each other. Similarly, the piston side 116 and the piston rod side 118 of the second hydraulic cylinder are arranged in fluid communication with each other.

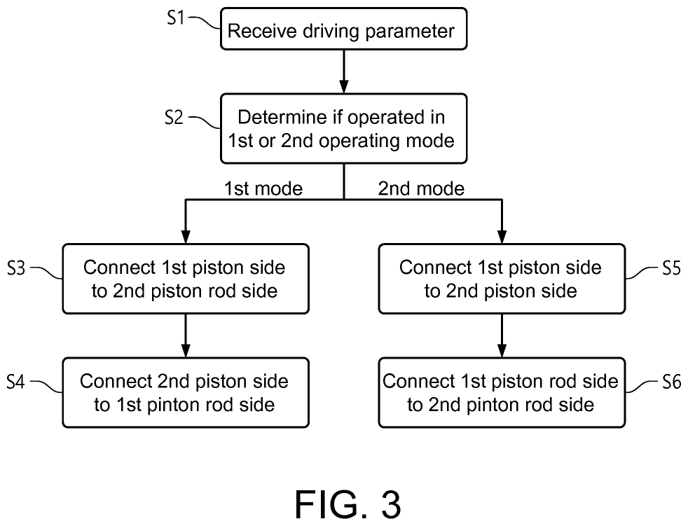

In order to describe an example embodiment of a method of operating the above described suspension system 100, reference is made to FIG. 3 in combination with FIG. 2. When operating the vehicle 1, a driving parameter for the vehicle 1 is received S1. The driving parameter may relate to e.g. if the vehicle is operated in rough terrain, driving straight ahead on a flat surface, is taking a curve, etc. The driving parameter may preferably be dependent on at least one of a steering direction and vehicle speed of the vehicle. Hence, a signal indicative of how the vehicle is operated is received by the control unit 200. The signal may also relate to an upcoming driving condition for the vehicle.

Based on the received operating parameter, it is thereafter determined S2 if the vehicle is operated in a first or second operating mode. The first operating mode may relate to the vehicle being operated in a curvature where the suspension system 100 is in need of providing a relatively stable condition for the vehicle 1. The second operating mode may on the other hand relate to operation in a relatively rough terrain where sufficient comfort is desirable.

If it is determined that the vehicle 1 is operated in the first operating mode, i.e. the vehicle is taking a curvature or the like and there is a desire to operate the vehicle 1 in a stable manner, the piston side 112 of the first hydraulic cylinder 104 is connected S3 to the piston rod side 118 of the second hydraulic cylinder 108, and the piston rod side 114 of the first hydraulic cylinder 104 is connected S4 to the piston side 116 of the second hydraulic cylinder 108.

On the other hand, if it is determined that the vehicle 1 is operated in the second operating mode, i.e. the vehicle is driving in rough terrain or the like, the piston side 112 of the first hydraulic cylinder 104 is connected S5 to the piston side 116 of the second hydraulic cylinder 108, and the piston rod side 114 of the first hydraulic cylinder 104 is connected S6 to the piston rod side 118 of the second hydraulic cylinder 108.

The vehicle 1 may also be operated in a third or fourth operating state, in which the valve unit 110 is arranged in the third 306 or fourth position, respectively.

The vehicle 1 may be operated in the first operating mode, where after it is determined that the driving condition has changed, i.e. an updated driving parameter is received, such that the vehicle should be operated in the second operating mode. In such a case, the control unit 200 controls the valve unit 110 to be switched from the first position 302 to the second position 304. When, or slightly before, switching between the positions of the valve unit 110, the position of the first 120 and second 130 reciprocating pistons within their respective hydraulic cylinder is preferably determined. Preferably, the first 120 and second 130 reciprocating pistons should be arranged on a similar position within their respective cylinder before switching the position of the valve unit 110.

Although not depicted, the driving parameter of the vehicle 1 may be determined based on signals received from various types of sensors. For example, the vehicle speed may be determined from a vehicle speed sensor, and that the vehicle is taking a curvature may be determined by a sensor connected to the steering wheel of the vehicle or a sensor determining the relative inclination between the tractor unit 2 and the trailer unit 4 of the vehicle, etc.

Although the figures may show a sequence the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps. Additionally, even though the invention has been described with reference to specific exemplifying embodiments thereof, many different alterations, modifications and the like will become apparent for those skilled in the art.

1. A suspension system for a vehicle, the suspension system comprising:
a first suspension arrangement comprising a first hydraulic cylinder;
a second suspension arrangement comprising a second hydraulic cylinder; and
a valve unit arranged in fluid communication between the first and second hydraulic cylinders, wherein
the valve unit being controllable between a first state in which a piston side of the first hydraulic cylinder and a piston rod side of the second hydraulic cylinder are arranged in fluid communication with each other, and a piston rod side of the first hydraulic cylinder and a piston side of the second hydraulic cylinder are arranged in fluid communication with each other; and a second state in which the piston side of the first hydraulic cylinder and the piston side of the second hydraulic cylinder are arranged in fluid communication with each other, and the piston rod side of the first hydraulic cylinder and the piston rod side of the second hydraulic cylinder are arranged in fluid communication with each other.

2. The suspension system according to claim 1, further comprising a control unit for controlling the valve unit to be operated between the first and second states.

3. The suspension system according to claim 2, wherein the first hydraulic cylinder comprises a first reciprocating piston and the second hydraulic cylinder comprises a second reciprocating piston, the control unit being configured to:
receive a signal indicative of a position of the first and the second piston within the respective first and second hydraulic cylinder;
compare the position of the first piston and the position of the second piston with each other;
control the valve unit to be switchable between the first and second states if when the relative position between the first and second pistons is below a predetermined threshold limit.

4. The suspension system according to claim 1, wherein the valve unit is controllable between the first and second states based on at least one of a steering direction and a vehicle speed of the vehicle.

5. The suspension system according to claim 2, wherein the control unit is further configured to:
receive a signal indicative of a steering direction for the vehicle;
compare the steering direction with a predetermined threshold angle;
when an angle of the steering direction exceeds the predetermined threshold angle:
control the valve unit to be positioned in the first state; and
when the angle of the steering direction is below the predetermined threshold angle:
control the valve unit to be positioned in the second state.

6. The suspension system according to claim 2, wherein the control unit is further configured to:
receive a signal indicative of an inclination in the transversal direction of the vehicle;
compare the inclination with a maximum allowable inclination; and
when the inclination exceeds the maximum allowable inclination:
inhibit the valve unit from being positioned in the second state.

7. The suspension system according to claim 1, wherein the valve unit is further controllable to assume a third state in which the first and second hydraulic cylinders are disconnected from each other.

8. The suspension system according to claim 1, wherein the valve unit is further controllable to assume a fourth state in which the piston side and the piston rod side of the first hydraulic cylinder are arranged in fluid communication with each other, and the piston side and the piston rod side of the second hydraulic cylinder are arranged in fluid communication with each other.

9. The suspension system according to claim 1, wherein the first and second hydraulic cylinders are arranged on opposite sides of the vehicle as seen in the longitudinal direction of the vehicle.

10. The suspension system according to claim 1, the suspension system being a wheel suspension system, wherein the first and second hydraulic cylinders are arranged to be connected to a respective wheel axle or to a respective side of a wheel axle of the vehicle.

11. A method for selectively controlling a suspension system of a vehicle, the vehicle being operated in at least a first and a second operating mode, wherein the suspension system comprises a first suspension arrangement comprising a first hydraulic cylinder, and a second suspension arrangement comprising a second hydraulic cylinder, wherein the first and second hydraulic cylinders are fluidly connectable to each other, the method comprising the steps of:
receiving a driving parameter for the vehicle;
determining when the vehicle is operated in the first operating mode or the second operating mode based on the received driving parameter for the vehicle;
when the vehicle is operated in the first operating mode:
connecting a piston side of the first hydraulic cylinder and a piston rod side of the second hydraulic cylinder to each other; and
connecting a piston rod side of the first hydraulic cylinder and a piston side of the second hydraulic cylinder to each other;
when the vehicle is operated in the second operating mode:
connecting the piston side of the first hydraulic cylinder and the piston side of the second hydraulic cylinder to each other; and
connecting the piston rod side of the first hydraulic cylinder and the piston rod side of the second hydraulic cylinder to each other.

12. A computer program comprising program code means for performing the steps of claim 11 when the program is run on a computer.

13. A computer readable medium carrying a computer program comprising program means for performing the steps of claim 11 when the program means is run on a computer.

14. A vehicle comprising a suspension system according to claim 1.
